(19) United States
(12) Patent Application Publication
(10) Pub. No.: US 2016/0123573 A1
(43) Pub. Date: May 5, 2016

(54) Luminous Floor

(71) Applicant: PENG HSIANG LAI, Wanchai (HK)

(72) Inventor: PENG HSIANG LAI, Wanchai (HK)

(21) Appl. No.: 14/645,188

(22) Filed: Mar. 11, 2015

(30) Foreign Application Priority Data
Oct. 31, 2014 (CN) 201420641798.3

(51) Int. Cl. F21V 33/00

(52) U.S. Cl. CPC F21V 33/006

(57) ABSTRACT

A luminous floor, comprising the floor bottom body and vibrant luminous core installed in said floor bottom body, Said floor bottom body has bayonet around, said vibrant luminous core includes electric connectivity light-emitting device and power, and there are vibration switches between said light-emitting device and power. The number of said vibrant luminous core is various. Said floor bottom body includes base plate with mounting hole, and said vibrant luminous core is installed in the hole. Said floor bottom body also includes the transparent plate installed at the side of and fitted into said base plate. A luminous floor combination of such structure is convenient and suitable for occasion without outer power.

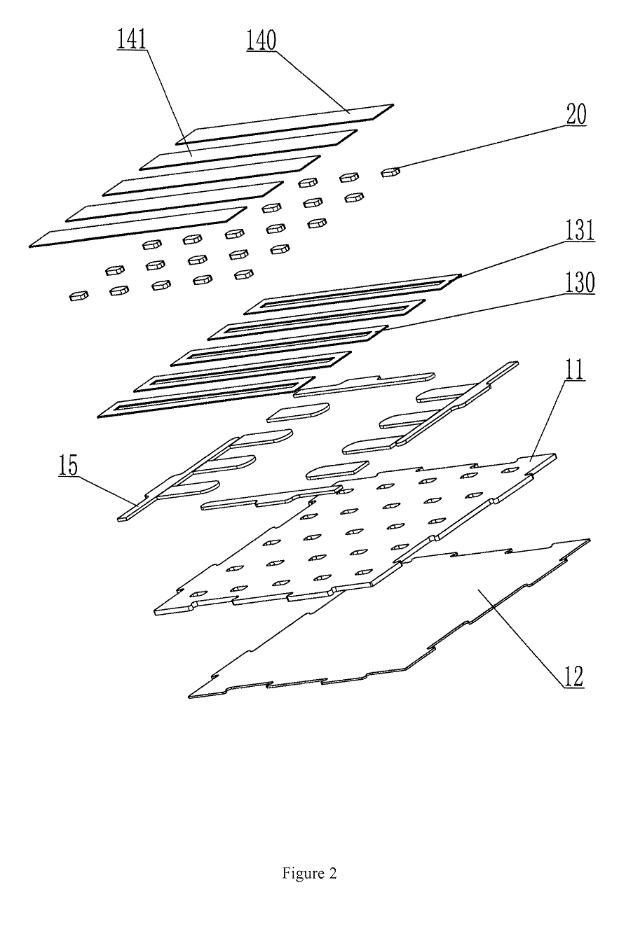

FIG. 2 is specified as abstract figure.

### TECHNICAL FIELD

This utility model involves a type of floor, a luminous floor in particular.

### BACKGROUND TECHNOLOGY

Currently luminous flooring available in the market is usually electrified with outer power, which not only consumes more time and energy in connecting all circuits together while laying the luminous floor, but is totally out of service in the absence of an external power supply. Such inconvenience leads to huge restriction on the usage scenarios. Generally, this kind of traditional luminous flooring cannot be used in the occasion without power. In addition, its light-emitting control is mostly realized by manipulating the program written into the chip, which makes the control circuit more complicated and increases the cost. What's more, such luminous flooring controlled by program has no interaction with user, and cannot provide good waterproof function due to its dependence on outer power. In conclusion, what we need most urgently is a luminous floor which can be used in outer power-free occasion and fit together freely as required.

### Content of Utility Model

The technical problem tackled by this utility model is to provide a type of luminous floor which can be used in outer power-free occasion and fit together freely as required.

To address the foresaid technical problem, this utility model provides the following solution: A luminous floor, comprising the floor bottom body and vibrant luminous core installed in said floor bottom body. The key issue is said floor bottom body has bayonet around, said vibrant luminous core includes electric connectivity light-emitting device and power, and there are vibration switches between said light-emitting device and power.

As improvement I of this utility model, the number of said vibrant luminous core is multiple.

As further improvement of this utility model, said floor bottom body includes base plate with mounting hole, and said vibrant luminous core is installed in the hole.

As further improvement of this utility model, said floor bottom body also includes the transparent plate installed at the side of and fitted into said base plate.

As optimized improvement, said transparent plate is Acrylic plate.

As improvement II of this utility model, said floor bottom body also includes the first magic layer fitted into the other side of said plate, said first magic layer includes multiple magic straps installed side by side, and the area of said first magic straps corresponding to said vibrant luminous core is the pierced area.

As further improvement of this utility model, said floor bottom body also includes the second magic layer fitted into said first magic layer. Said second magic layer includes multiple second magic straps, the number of said second magic straps is identical with that of said first magic straps and fitted together correspondingly. The shape of outer edge of said second magic straps is identical with that of the first magic straps.

As even further improvement of this utility model, there is elastic layer filled among said first magic straps, and said elastic layer adopts EVA material.

As even further more improvement of this utility model, the shape of outer edge of the elastic layer distributed around said floor bottom body is identical with that of said floor bottom body.

The following beneficial effects are achieved through implementation this utility model:

A luminous floor, comprising the floor bottom body and vibrant luminous core installed in said floor bottom body. Said floor bottom body has bayonet around, said vibrant luminous core includes electric connectivity light-emitting device and power, and there are vibration switches between said light-emitting device and power.

When in use, fit the multiple numbers of luminous floors together via the bayonet on the floor bottom body to form an area that meets the demand. When people walk on it or the vibration luminous bottom is subject to other vibration, the vibration switches will be turned on and the light-emitting device will give out light, which makes it function without having to relying on outer power. Meanwhile, it will give out light when people make movement, which establishes an interaction between the floor and people. Such a structure makes it possible for the floor to be laid on occasions such as stage, basketball court, badminton court as well as volleyball court. Controlling the light-emitting device via vibration switches can make it simple and small for the structure of luminous floor and less prone to have failure. The number of said vibrant luminous core is various. Setting various vibrant luminous cores can ensure that even if there are some faulty cores, other normal cores can meet the usage requirement. Said floor bottom body includes base plate with mounting hole, and said vibrant luminous core is installed in the hole. Said floor bottom body also includes the transparent plate installed at the side of and fitted into said base plate. Said transparent plate is Acrylic plate. Said floor bottom, body also includes the first magic layer fitted into the other side of said plate, said first magic layer includes multiple magic straps installed side by side, and the area of said first magic straps corresponding to said vibrant luminous core is the pierced area. Said floor bottom body also includes the second magic layer fitted into said first magic layer. Said second magic layer includes multiple second magic straps, the number of said second magic straps is identical with that of said first magic straps and fitted together correspondingly. The shape of outer edge of said second magic straps is identical with that of the first magic straps. There is elastic layer filled among said first magic straps, said elastic layer adopts EVA material, and the shape of outer edge of the elastic layer distributed around said floor bottom body is identical with that of said floor bottom body. Luminous floor of such structure can provide better protection for luminous core and avoid malfunction resulting from improper outer use. Meanwhile, such structure has better waterproof function which prevents the core from breaking down due to exposure to water, and the light from the light-emitting device will illuminate through the transparent plate.

### ILLUSTRATION

Further detailed description is provided in the following illustration:

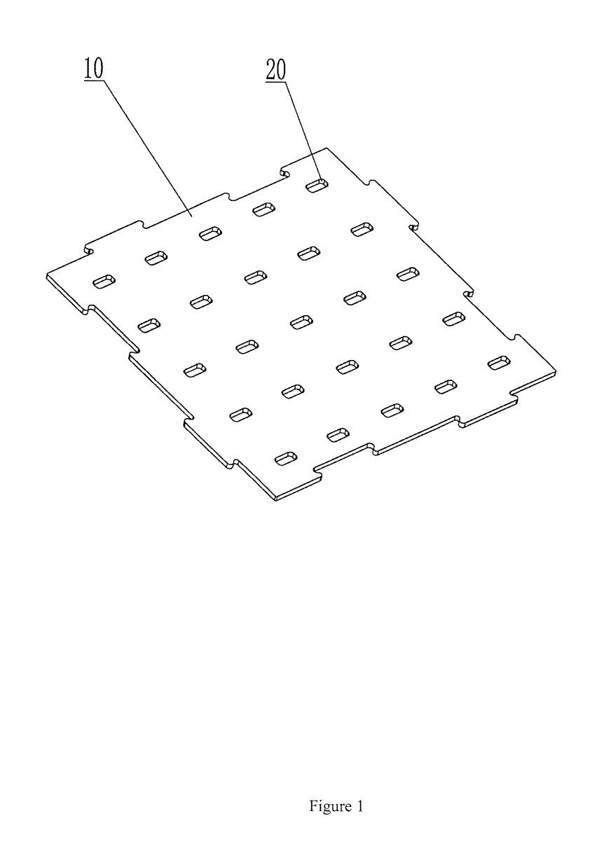

FIG. 1 describes the overall structure of the utility model;

FIG. 2 describes the detachment of the utility model;

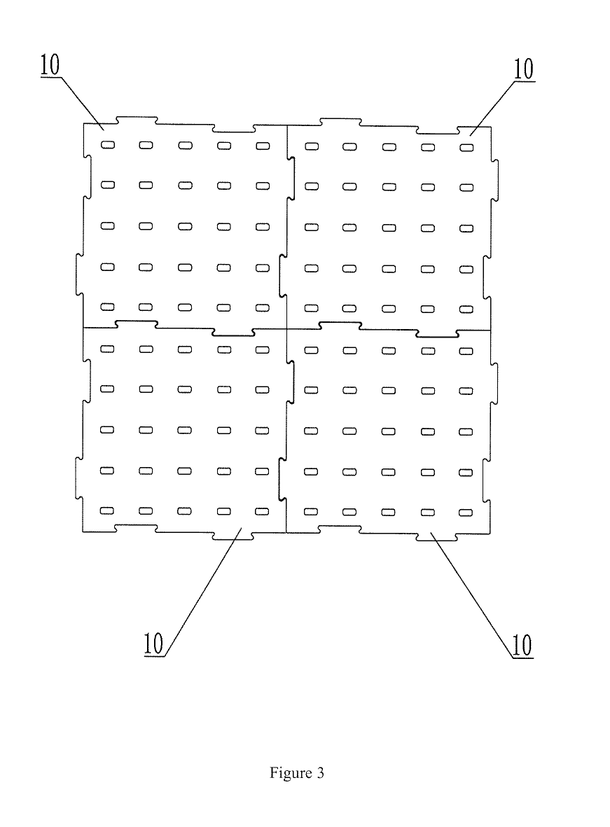

FIG. 3 describes the assembly of the utility model;

### SPECIFIC WAY OF IMPLEMENTATION

As shown in FIGS. 1 and 2, a luminous floor, comprising the floor bottom body 10 and vibrant luminous core 20 installed in said floor bottom body 10, Said floor bottom body 10 has bayonet around it, said vibrant luminous core 20 includes electric connectivity light-emitting device and power, and there are vibration switches between said light-emitting device and power. The number of said vibrant luminous core 20 is various. Said floor bottom body 10 includes base plate with mounting hole 11, and said vibrant luminous core 20 is installed in the hole. Said floor bottom body 10 also includes the transparent plate 12 installed at the side of and fitted into said base plate 11. Said transparent plate 12 is Acrylic plate. Said floor bottom body 10 also includes the first magic layer 130 fitted into the other side of said plate 11, said first magic layer 130 includes multiple magic straps 131 installed side by side, and the area of said first magic strap 131 corresponding to said vibrant luminous core 20 is the pierced area. Said floor bottom body 10 also includes the second magic layer 140 fitted into said first magic layer 130. Said second magic layer 140 includes multiple second magic straps 141, the number of said second magic straps 141 is identical with that of said first magic straps 131 and fitted together correspondingly. The shape of outer edge of said second magic straps 141 is identical with that of the first magic straps 131. There is elastic layer 15 filled among said first magic straps 131, said elastic layer 15 adopts EVA material, and the shape of outer edge of the elastic layer 15 distributed around said floor bottom body 10 is identical with that of said floor bottom body 10.

As shown in FIG. 3, when various luminous floors are combined, they are fitted together via the bayonet set on the floor bottom body 10.

It must be pointed out that said implementation only serves as an illustrational example for the utility model on a non-finite basis. However, technicians in this field understand that without deviating from the purpose and range of the utility model, modification, replacement and alternation are allowed, and such modification, replacement and alternation still fall into the protective range of the utility model.

1. A luminous floor, comprising a floor bottom body and at least one vibrant luminous core installed in the floor bottom body, wherein the floor bottom body has a bayonet around, the vibrant luminous core includes electric connectivity light-emitting device and power, and there are vibration switches between said-the light-emitting device and power.

2. The luminous floor according to claim 1, comprising more than one vibrant luminous core.

3. The luminous floor according to claim 2, wherein the floor bottom body includes a base plate with a mounting hole, and the vibrant luminous core is installed in the mounting hole.

4. The luminous floor according to claim 3, wherein the floor bottom body also includes a transparent plate installed at the side of and fitted into the base plate.

5. The luminous floor according to claim 4, wherein the transparent plate an Acrylic plate.

6. The luminous floor according to claim 3, wherein the floor bottom body also includes a first magic layer fitted into the other side of the base plate, wherein the first magic layer includes multiple magic straps installed side by side, and the area of the first magic straps corresponding to the vibrant luminous core is the pierced area.

7. The luminous floor according to claim 6, wherein the floor bottom body also includes a second magic layer fitted into the first magic layer, wherein the second magic layer includes multiple second magic straps, the number of the second magic straps is identical with that of the first magic straps and fitted together correspondingly, and the shape of the outer edge of the second magic straps is identical with that of the first magic straps.

8. The luminous floor according to claim 7, further including an elastic layer filled among the first magic straps.

9. The luminous floor according to claim 8, wherein the elastic layer adopts EVA material.

10. The luminous floor according to claim 9, wherein the shape of the outer edge of the elastic layer distributed around the floor bottom body is identical with that of the floor bottom body.
